(19) United States
(12) Patent Application Publication
(10) Pub. No.: US 2022/0003714 A1
(43) Pub. Date: Jan. 6, 2022

(54) ULTRASOUND SCANNING APPARATUS FOR SCANNING NON-PLANAR SURFACES

(71) Applicant: DolphiTech AS, Gjøvik (NO)

(72) Inventors: Eskil Skoglund, Gjøvik (NO); Fredrik Lingvall, Gjøvik (NO); Tore Magne Skaar, Gjøvik (NO)

(21) Appl. No.: 17/288,893

(22) PCT Filed: Oct. 25, 2019
(86) PCT No.: PCT/EP2019/079194

§ 371 Date: Apr. 26, 2021

(30) Foreign Application Priority Data
Oct. 26, 2018 (GB) 1817501.8

(51) Int. Cl. G01N 29/04; G01N 29/22

(52) U.S. Cl. CPC G01N 29/041; G01N 29/226; G01N 2291/106; G01N 2291/2634; G01N 2291/265

(57) ABSTRACT

A scanning apparatus for imaging an object, the scanning apparatus comprising: a transmitter for transmitting ultrasound signals towards an object, a receiver for receiving ultrasound signals from an object, and a support, the transmitter and the receiver being coupled to the support; the scanning apparatus being capable of being operated with the support in a non-planar configuration thereby to scan a non-planar surface of an object.

### CROSS-REFERENCE TO RELATED APPLICATIONS

The present application is the national stage entry of International Patent Application No. PCT/EP2019/079194, filed on Oct. 25, 2019, and claims priority to Application No. GB 1817501.8, filed in the United Kingdom on Oct. 26, 2018, the disclosures of which are expressly incorporated herein in its entirety by reference thereto.

### FIELD OF THE INVENTION

The present invention relates to a scanning apparatus for imaging an object, for instance a scanning apparatus for imaging structural features below an object's surface. The scanning apparatus may be particularly useful for imaging sub-surface material defects such as delamination, debonding and flaking.

### BACKGROUND

Ultrasound is an oscillating sound pressure wave that can be used to detect objects and measure distances. A transmitted sound wave is reflected and refracted as it encounters materials with different acoustic impedance properties. If these reflections and refractions are detected and analysed, the resulting data can be used to describe the environment through which the sound wave travelled.

Ultrasound can be used to identify particular structural features in an object. For example, ultrasound may be used for non-destructive testing by detecting the size and position of flaws in a sample. There are a wide range of applications that can benefit from non-destructive testing, covering different materials, sample depths and types of structural feature, such as different layers in a laminate structure, impact damage, boreholes etc. Therefore, there is a need for a sensing apparatus that is capable of performing well in a wide-range of different applications.

### SUMMARY

According to an aspect of the present invention, there is provided a scanning apparatus for imaging an object, the scanning apparatus comprising:
a transmitter for transmitting ultrasound signals towards an object,
a receiver for receiving ultrasound signals from an object, and
a support, the transmitter and the receiver being coupled to the support;
   the scanning apparatus being capable of being operated with the support in a non-planar configuration thereby to scan a non-planar surface of an object.

The scanning apparatus may be configured so that the support being in the non-planar configuration causes a scanning surface of the scanning apparatus to comprise one of, or a combination of: a concave configuration, a convex configuration, a part-spherical configuration, and a configuration with a plurality of non-parallel planes.

The scanning apparatus may be configured to control the transmission of ultrasound signals by the transmitter in dependence on the non-planar configuration. The scanning apparatus may be configured to control the transmission of ultrasound signals by the transmitter in dependence on the configuration of the support.

The scanning apparatus may be configured to control a linear array of transducer elements to transmit an ultrasound signal. The scanning apparatus may be configured to control a non-linear array of transducer elements to transmit an ultrasound signal.

The support may be arranged to adopt the non-planar configuration on pressing the scanning apparatus against a non-planar surface of an object. The support may be flexible.

The support may comprise a flexible lip extending away from a body of the scanning apparatus. A portion of the support abutting the body of the scanning apparatus may be more rigid than the lip. The lip may be configured to flex in two dimensions.

The support may have a non-planar configuration when not acted upon by external forces.

Where the non-planar configuration comprises a first plane coupled to a second plane, the two planes being coupled at an angle of less than 180 degrees to a first side of the planes and at an angle of greater than 180 degrees to a second side of the planes, the scanning apparatus may be configured to scan objects to one or both of the first side and the second side. The scanning apparatus may comprise one transmitter disposed on the first plane and another transmitter disposed on the second plane. The scanning apparatus may comprise a further transmitter disposed back to back with one of the transmitter on the first plane and the transmitter on the second plane.

The transmitter and the receiver may respectively comprise first and second transmitters and receivers, and the support may comprise first and second support portions. The scanning apparatus may comprise: a first scanning module comprising the first transmitter, the first receiver, and the first support portion, the first transmitter and the first receiver being coupled to the first support portion, and a second scanning module comprising the second transmitter, the second receiver, and the second support portion, the second transmitter and the second receiver being coupled to the second support portion; wherein the first scanning module and the second scanning module may be movable relative to one another so as to enable the support to adopt the non-planar configuration.

The first scanning module and the second scanning module may be pivotally movable relative to one another. One or both of the first scanning module and the second scanning module may comprise one of, or a combination of, a curved surface and a planar surface.

The scanning apparatus may comprise a coupling material for facing an object for imaging.

According to another aspect of the present invention, there is provided a method of operating an ultrasound scanning apparatus for imaging an interior of an object, the scanning apparatus comprising a matrix array of transducer elements configured to transmit and receive ultrasound signals, the method comprising:
determining a non-planar configuration of the matrix array; and
controlling the matrix array to emit ultrasound signals in dependence on the determined non-planar configuration.

Controlling the matrix array may comprise controlling a linear array of transducer elements of the matrix array to emit an ultrasound signal. Controlling the matrix array may comprise controlling a non-linear array of transducer elements of the matrix array to emit an ultrasound signal.

According to another aspect of the present invention, there is provided a method of operating an ultrasound scanning apparatus for imaging an interior of an object, the scanning apparatus comprising a matrix array of transducer elements configured to transmit and receive ultrasound signals, the method comprising:
modifying the matrix array thereby to cause the matrix array to adopt a non-planar configuration;
moving the scanning apparatus into contact with an object;
controlling the matrix array to emit ultrasound signals and to receive reflected ultrasound signals.

Modifying the matrix array may comprise driving a joint between two portions of the matrix array. At least one of the portions of the matrix array may comprise a plurality of transducer elements arranged on a common plane.

According to another aspect of the present invention, there is provided a coupling shoe for attachment to a transducer module to couple ultrasound transmitted by the transducer module into a target object, the coupling shoe comprising:
a transducer coupling surface for abutment to an ultrasound-emitting surface of the transducer module to couple ultrasound into the coupling shoe;
a probe surface for facing the target object to couple ultrasound into the target object; and
a side surface forming at least a part of a periphery of the coupling shoe, the side surface being transverse to at least one of the transducer coupling surface and the probe surface;
the periphery of the coupling shoe comprising an ultrasound-attenuating structure.

The ultrasound-attenuating structure may reduce the intensity of side reflections within the coupling shoe by one or more of: increasing a path length of the side reflections; and absorbing energy of the side reflections. The side surface may be at an angle of approximately 90 degrees to at least one of the transducer coupling surface and the probe surface. The side surface may be at an acute angle to the probe surface. The side surface may be angled outwardly in a direction from the transducer coupling surface to the probe surface.

The ultrasound-attenuating structure may comprise a material having a greater absorption in at least one ultrasound frequency than a bulk of the coupling shoe. The ultrasound-attenuating structure may comprise a plurality of layers of differing impedances. The ultrasound-attenuating structure may comprise a plurality of particles, the particles being of a material having a different impedance from the bulk of the coupling shoe. The plurality of particles may comprise particles of differing size and/or materials. The plurality of particles may comprise particles of material selected from a group comprising: a metal; tungsten; nickel, steel; and iron oxide.

The ultrasound-attenuating structure may comprise one or more protrusion and/or indentation. The ultrasound-attenuating structure may comprise one or more of: a curved protrusion; a curved indentation; an angular protrusion; and an angular indentation. The protrusion and/or indentation may have a generally hemispherical shape. The ultrasound-attenuating structure may comprise a plurality of protrusions and/or indentations which are arranged in one or more rows along the periphery of the coupling shoe. At least two of the plurality of protrusions and/or indentations may abut one another. A first row may be offset from a second row in a first direction, and protrusions and/or indentations in the first row may be offset from protrusions and/or indentations in the second row in a second direction, transverse to the first direction. The plurality of protrusions and/or indentations may be provided circumferentially about the coupling shoe. The plurality of protrusions and/or indentations may be aligned halfway along the side surface in a direction transverse to a circumferential direction about the coupling shoe.

The one or more protrusions and/or indentations may be exposed at the surface of the coupling shoe.

The coupling shoe may comprise: a recess for receiving a portion of the transducer module; or a plurality of recesses for receiving respective portions of a plurality of transducer modules. The coupling shoe may comprise material from a group comprising: an epoxy; an elastomer; aqualene; plexiglass; and Rexolite. The coupling shoe may comprise a resilient material for conforming to a surface of the target object.

The coupling shoe may be shaped to conform to a surface of the target object, the probe surface comprising one or more of: a flat surface; a convex surface; and a concave surface. The coupling shoe may be configured such that one or more of: the flat surface is at an angle to the transducer coupling surface; the convex surface and/or the concave surface comprises a part-spherical surface; and the convex surface and/or the concave surface comprises a part-cylindrical surface.

According to another aspect of the present invention, there is provided a coupling shoe for attachment to a transducer module to couple ultrasound transmitted by the transducer module into a target object, the coupling shoe comprising: a transducer coupling surface for abutment to an ultrasound-emitting surface of the transducer module to couple ultrasound into the coupling shoe; a probe surface for facing the target object to couple ultrasound into the target object; and a side surface forming at least a part of a periphery of the coupling shoe, the side surface being transverse to at least one of the transducer coupling surface and the probe surface; the probe surface being configured to conform to a surface of the target object.

Any one or more features of any aspect above may be combined with any one or more features of any other aspect. These have not been written out in full here merely for the sake of brevity.

### BRIEF DESCRIPTION OF THE FIGURES

The present invention will now be described by way of example with reference to the accompanying drawings. In the drawings:

FIG. 1 shows a device for imaging an object;

FIG. 2 shows an example of a scanning apparatus and an object;

FIG. 3 shows an example of the functional blocks of a scanning apparatus;

FIG. 4 shows an exploded view of an example scanning apparatus;

FIG. 5 shows an example arrangement of transducer elements;

FIG. 6 shows an example of an electrode array;

FIG. 7 shows an example of overlaid electrode arrays;

FIGS. 8a to 8c show other examples of an electrode array;

FIG. 9 shows an example of a non-planar configuration of a scanning apparatus;

FIGS. 10a to 10c show other examples of non-planar configurations of a scanning apparatus;

FIGS. 11a and 11b show examples of a scanning apparatus comprising a plurality of planes coupled by one or more joint;

FIG. 12 a, b, c show examples of a transducer flexed in one dimension;

FIG. 13 shows an example of a transducer module and coupling shoe;

FIG. 14 shows an example of a coupling shoe with curved corners;

FIG. 15 shows an example of a coupling shoe with a curved probe surface;

FIG. 16 shows a perspective view from underneath of a coupling shoe with a curved probe surface;

FIG. 17 shows another example of a coupling shoe with a curved probe surface;

FIG. 18 shows two examples of coupling shoes with angular probe surfaces;

FIG. 19 shows another example of a coupling shoe;

FIG. 20 shows an example of a coupling shoe for multiple transducer modules;

FIG. 21 shows an example of a coupling shoe with flared sides;

FIG. 22 shows an example of a coupling shoe with ultrasound-attenuating structures;

FIG. 23 shows another example of a coupling shoe with ultrasound-attenuating structures;

FIG. 24 shows another example of a coupling shoe with ultrasound-attenuating structures;

FIGS. 25A, 25B and 25C show further examples of ultrasound-attenuating structures of coupling shoes;

FIG. 26A shows a perspective view of a coupling shoe comprising indentations;

FIG. 26B shows a side view of the coupling shoe of FIG. 26A;

FIG. 27A shows a perspective view of another coupling shoe comprising indentations;

FIGS. 27B and 27C show side views of the coupling shoe of FIG. 27A;

FIG. 27D shows a sectional view of the coupling shoe of FIG. 27A;

FIG. 28A shows a perspective view of another coupling shoe comprising indentations;

FIGS. 28B and 28C show side views of the coupling shoe of FIG. 28A;

FIG. 28D shows a sectional view of the coupling shoe of FIG. 28A;

FIG. 29A shows a perspective view of another coupling shoe comprising indentations;

FIGS. 29B and 29C show side views of the coupling shoe of FIG. 29A;

FIG. 29D shows a sectional view of the coupling shoe of FIG. 29A;

FIG. 30 shows another transducer module comprising a transducer and multiple coupling shoes for attachment to the transducer module;

FIG. 31A shows an attachment between a transducer module and a coupling shoe;

FIG. 31B shows a side view of the transducer module and coupling shoe of FIG. 31A;

FIG. 31C shows a sectional view along line A-A of FIG. 31B;

FIG. 32 shows a scanning apparatus with a flexible lip; and

FIG. 33 shows electrode arrangements for the scanning apparatus of FIG. 32.

### DETAILED DESCRIPTION

A scanning apparatus may gather information about structural features located different depths below the surface of an object. One way of obtaining this information is to transmit sound pulses at the object and detect any reflections. It is helpful to generate an image depicting the gathered information so that a human operator can recognise and evaluate the size, shape and depth of any structural flaws below the object's surface. This is a vital activity for many industrial applications where sub-surface structural flaws can be dangerous. An example is aircraft maintenance.

Usually the operator will be entirely reliant on the images produced by the apparatus because the structure the operator wants to look at is beneath the object's surface. It is therefore important that the information is imaged in such a way that the operator can evaluate the object's structure effectively.

Ultrasound transducers make use of a piezoelectric material, which is driven by electrical signals to cause the piezoelectric material to vibrate, generating the ultrasound signal. Conversely, when a sound signal is received, it causes the piezoelectric material to vibrate, generating electrical signals which can be detected.

It is desirable for a scanning apparatus comprising a transducer to be capable of closely fitting to a surface of an object to be imaged. The scanning apparatus might closely fit to the surface of the object in different ways. The scanning apparatus may be flexible so as to conform to the surface of the object as the scanning apparatus is pressed against the object. The scanning apparatus may be pre-configured, before placing it against the object, to conform to the surface profile of the object.

Enabling the scanning apparatus to be a close fit to a variety of objects, which might have varying surface profiles, increases the use of the scanning apparatus. Where the scanning apparatus is a close fit to an object to be imaged, the coupling between the scanning apparatus and the object, e.g. the coupling of ultrasound signals between the scanning apparatus and the object, is likely to be improved. Improving the coupling is likely to result in improvements in imaging of the object, since energy losses are likely to be lower.

Thus improving the fit between the scanning apparatus and an object is likely to improve the results of scanning that object with the scanning apparatus.

The provision of a scanning apparatus that is able to closely fit a range of differently-shaped objects is likely to improve efficiency, since the same scanning apparatus can be used for a variety of objects without significantly adversely affecting the results thereby obtained.

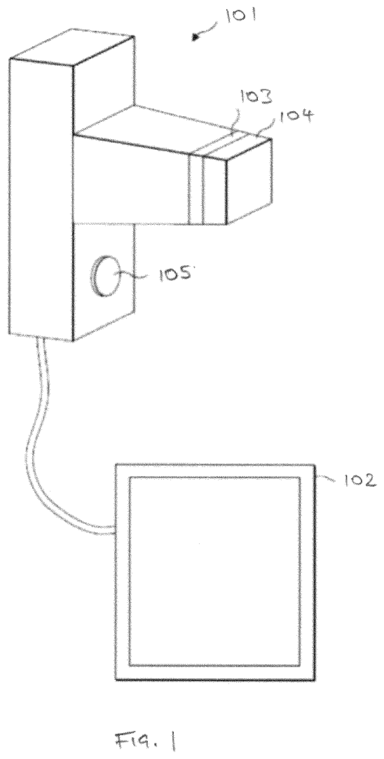

An example of a handheld device, such as a scanning apparatus described herein, for imaging below the surface of an object is shown in FIG. 1. The device 101 could have an integrated display, but in this example it outputs images to a tablet computer 102. The connection with the tablet could be wired, as shown, or wireless. The device has a matrix array 103 for transmitting and receiving ultrasound signals. Suitably the array is implemented by an ultrasound transducer comprising a plurality of electrodes arranged in an intersecting pattern to form an array of transducer elements. The transducer elements may be switched between transmitting and receiving. The handheld apparatus as illustrated comprises a coupling layer such as a dry coupling layer 104 for coupling ultrasound signals into the object. The coupling layer also delays the ultrasound signals to allow time for the transducers to switch from transmitting to receiving. A dry coupling layer offers a number of advantages over other imaging systems, which tend to use liquids for coupling the ultrasound signals. This can be impractical in an industrial environment. If the liquid coupler is contained in a bladder, as is sometimes used, this makes it difficult to obtain accurate depth measurements which is not ideal for non-destructive testing applications. The coupling layer need not be provided in all examples.

The matrix array 103 is two dimensional so there is no need to move it across the object to obtain an image. A typical matrix array might be approximately 30 mm by 30 mm but the size and shape of the matrix array can be varied to suit the application. The device may be straightforwardly held against the object by an operator. Commonly the operator will already have a good idea of where the object might have sub-surface flaws or material defects; for example, a component may have suffered an impact or may comprise one or more drill or rivet holes that could cause stress concentrations. The device suitably processes the reflected pulses in real time so the operator can simply place the device on any area of interest.

The handheld device also comprises a dial 105 or other user input device that the operator can use to change the pulse shape and corresponding filter. The most appropriate pulse shape may depend on the type of structural feature being imaged and where it is located in the object. The operator can view the object at different depths by adjusting the time-gating via the display. Having the apparatus output to a handheld display, such as the tablet 102, or to an integrated display, is advantageous because the operator can readily move the transducer over the object, or change the settings of the apparatus, depending on what is seen on the display and get instantaneous results. In other arrangements, the operator might have to walk between a non-handheld display (such as a PC) and the object to keep rescanning it every time a new setting or location on the object is to be tested.

A scanning apparatus for imaging structural features below the surface of an object is shown in FIG. 2. The apparatus, shown generally at 201, comprises a transmitter 202, a receiver 203, a signal processor 204 and an image generator 205. In some examples the transmitter and receiver may be implemented by an ultrasound transducer. The transmitter and receiver are shown next to each other in FIG. 2 for ease of illustration only. The transmitter 202 is suitably configured to transmit a sound pulse having a particular shape at the object to be imaged 206. The receiver 203 is suitably configured to receive reflections of transmitted sound pulses from the object. A sub-surface feature of the object is illustrated at 207.

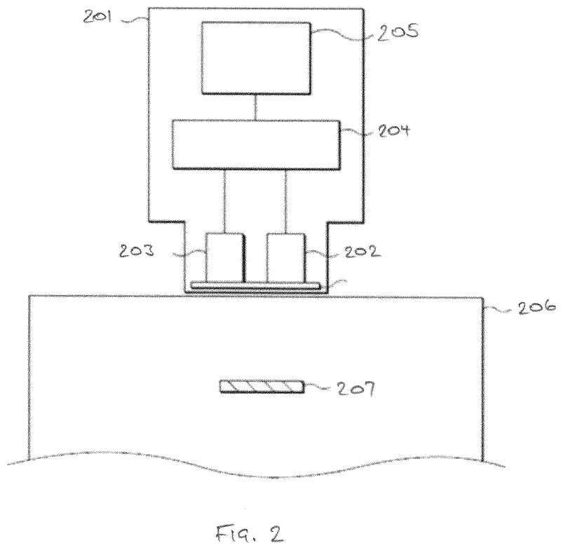

An example of the functional blocks comprised in one embodiment of the apparatus are shown in FIG. 3.

In this example the transmitter and receiver are implemented by an ultrasound transducer 301, which comprises a matrix array of transducer elements 312. The transducer elements transmit and/or receive ultrasound waves. The matrix array may comprise a number of parallel, elongated electrodes arranged in an intersecting pattern; the intersections form the transducer elements. The transmitter electrodes are connected to the transmitter module 302, which supplies a pulse pattern with a particular shape to a particular electrode. The transmitter control 304 selects the transmitter electrodes to be activated. The number of transmitter electrodes that are activated at a given time instant may be varied. The transmitter electrodes may be activated in turn, either individually or in groups. Suitably the transmitter control causes the transmitter electrodes to transmit a series of sound pulses into the object, enabling the generated image to be continuously updated. The transmitter electrodes may also be controlled to transmit the pulses using a particular frequency. The frequency may be between 100 kHz and 30 MHz, preferably it is between 0.5 MHz and 15 MHz and most preferably it is between 0.5 MHz and 10 MHz.

The receiver electrodes sense sound waves that are emitted from the object. These sound waves are reflections of the sound pulses that were transmitted into the object. The receiver module receives and amplifies these signals. The signals are sampled by an analogue-to-digital converter. The receiver control suitably controls the receiver electrodes to receive after the transmitter electrodes have transmitted. The apparatus may alternately transmit and receive. In one embodiment the electrodes may be capable of both transmitting and receiving, in which case the receiver and transmitter controls will switch the electrodes between their transmit and receive states. There is preferably some delay between the sound pulses being transmitted and their reflections being received at the apparatus. The apparatus may include a coupling layer to provide the delay needed for the electrodes to be switched from transmitting to receiving. Any delay may be compensated for when the relative depths are calculated. The coupling layer preferably provides low damping of the transmitted sound waves.

Each transducer element may correspond to a pixel in the image. In other words, each pixel may represent the signal received at one of the transducer elements. This need not be a one-to-one correspondence. A single transducer element may correspond to more than one pixel and vice-versa. Each image may represent the signals received from one pulse. It should be understood that “one” pulse will usually be transmitted by many different transducer elements. These versions of the “one” pulse might also be transmitted at different times, e.g. the matrix array could be configured to activate a “wave” of transducer elements by activating each line of the array in turn. This collection of transmitted pulses can still be considered to represent “one” pulse, however, as it is the reflections of that pulse that are used to generate a single image of the sample. The same is true of every pulse in a series of pulses used to generate a video stream of images of the sample.

The pulse selection module 303 selects the particular pulse shape to be transmitted. It may comprise a pulse generator, which supplies the transmitter module with an electronic pulse pattern that will be converted into ultrasonic pulses by the transducer. The pulse selection module may have access to a plurality of predefined pulse shapes stored in a memory 314. The pulse selection module may select the pulse shape to be transmitted automatically or based on user input. The shape of the pulse may be selected in dependence on the type of structural feature being imaged, its depth, material type etc. In general the pulse shape should be selected to optimise the information that can be gathered by the signal processor 305 and/or improved by the image enhancement module 310 in order to provide the operator with a quality image of the object.

FIG. 4 illustrates a scanning apparatus 400 in which layers comprising the scanning apparatus are shown in an exploded view. The transducer comprises a layer of piezoelectric material such as PVDF 402, with transmitter and receiver circuits 404, 406 to either side of the piezoelectric material. The transmitter and receiver circuits may be formed from very thin printed circuited boards. In one example the transmitter and receiver circuits comprise a plurality of elongated electrodes deposited in parallel lines on a flexible base layer (shown schematically in FIG. 4). The transmitter and receiver circuits may be laminated together. They may be arranged so that their respective electrodes overlap at right angles to form an intersecting pattern. The intersections form an array of transducer elements.

In some examples the transmitter and receiver circuits are respectively formed from copper deposited on a polyimide film. Each copper layer forms the electrodes. The electrodes might also be formed from other materials—gold, for example. The electrode layers can be bonded to the piezoelectric layer. In other examples, the electrodes may be deposited directly onto the piezoelectric layer.

The transducer also comprises a support 408 for supporting the transmitter and receiver circuits and the piezoelectric layer.

The scanning apparatus may be provided with a coupling layer 410 such as a dry coupling, for example an elastomer layer. The coupling layer may form the surface of the scanning apparatus. The coupling material may be flexible and/or compressible.

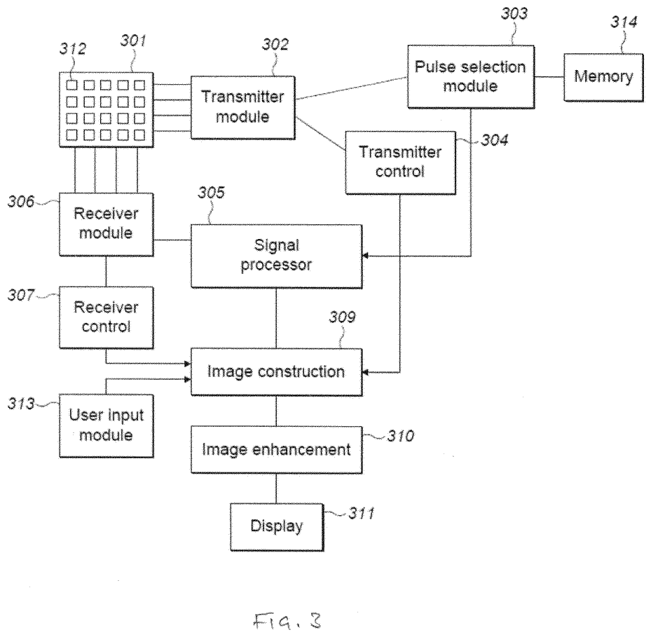

Referring to FIG. 5, in some examples the transducer electrodes (i.e. the transmitter 502 and/or receiver 504 electrodes) can be 210 μm in width 506. Thus the transducer elements, formed by the intersection of the transmitter and receiver electrodes, are 210×210 μm in size. The gap 508 between adjacent electrodes can be 40 μm. The pitch 510 between adjacent transducer elements can be 250 μm.

The number of transmitter and receiver electrodes is scalable. Hence transducers can be designed of any desired size and shape. The electrode width is also scalable to adjust the amount of energy output per electrode. The electrode width can also be adjusted in dependence on the desired focus. The distance between the electrodes might also be varied. Generally it is preferred to have small gaps between neighbouring electrodes to maximise ultrasound energy by stimulating as large an area of the piezoelectric layer as possible. The thickness of the electrodes may be chosen to control factors such as frequency, energy and beam focus. The thickness of the base film may be chosen to control factors such as signal shape, frequency and energy. The PVDF thickness can also be adapted to change signal shape, frequency and energy (which are also dependent on the transmitting pulse shape). In some examples, the pitch between transducer elements can be reduced to 125 μm.

An example of electrodes for forming one or other of the transmitter or receiver electrode array is shown in FIG. 6. A limited number of individual electrodes are shown in the figure for clarity. There are 128 electrodes in some examples. In other examples more or fewer electrodes can be provided. There is provided a connection region 602 for coupling the electrodes to driver and/or reception electronics. Suitably the connection region is of a standard size for coupling to a standard connection. A standard connection may be configured to connect to up to 128 electrodes. The area of the electrode array for forming transducer elements (indicated at 604) may be of a different width from the connection region. As illustrated, the array is slightly elongate.

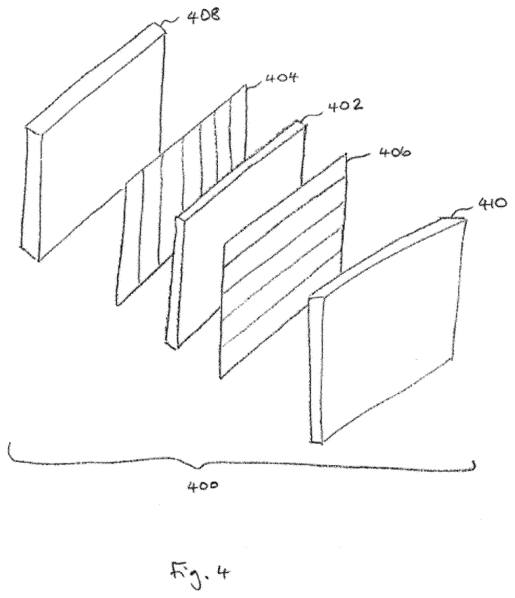

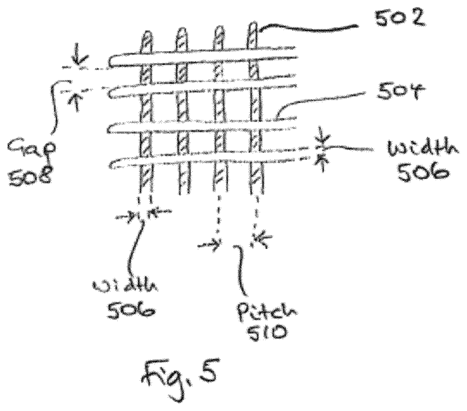

An example of overlaying the array of FIG. 6 with another array at right angles to it is shown in FIG. 7. One of the arrays acts as the transmitter electrode and the other of the arrays acts as the receiver electrode. In this example, the area defined by the overlap of the electrodes is square, hence defining a square transducer array. Each transducer element is formed by an intersection between a transmitter electrode and a receiver electrode. In other examples, different sizes and/or shapes of electrode array can be provided. This can lead to different sizes and/or shapes of transducer array. Some examples of such different electrode arrays are provided in FIGS. 8a to 8c. Other shapes and/or sizes are possible.

The electrode width and/or spacing can be varied in such electrode arrays. The electrodes need not be of equal widths along their lengths. The electrodes need not be of equal widths to one or more other electrode in the array, and/or in the other of the transmitter and receiver electrode array. The electrodes need not be equally spaced from neighbouring electrodes in the array.

The support is suitably arranged to adopt at least one non-planar configuration, whereby the scanning apparatus is conformable to a non-planar surface of an object. Suitably, where the support adopts a non-planar configuration, a scanning surface of the scanning apparatus adopts a non-planar shape. The scanning apparatus being conformable to a non-planar surface of an object permits the scanning apparatus to scan an interior of an object. The scanning apparatus is suitably capable of being operated with the support in a non-planar configuration thereby to scan a non-planar surface of an object. For example, the scanning apparatus can couple ultrasound signals into an object and receive ultrasound reflections from an object. The present arrangement can couple ultrasound signals into and out of an object more efficiently, thereby enabling a greater accuracy and/or shorter scan times.

Suitably, the transmitter and receiver conform to the non-planar surface of an object when the support is in the non-planar configuration. The conformity of the transmitter with the non-planar surface of an object facilitates efficient coupling of ultrasound signals transmitted by the transmitter into the object. The conformity of the receiver with the non-planar surface of an object facilitates efficient coupling of ultrasound signals reflected by or within the object into the receiver. The transmitter and receiver may conform to the non-planar configuration of the support. For example, the transmitter and receiver may adopt the same surface profile as the support.

The support may comprise a support structure. The support may provide structural support to the transmitter and receiver. The support may at least partially enclose or contain the transmitter and the receiver. In some examples the support can comprise a housing, for example a frame. The support may house the transmitter and the receiver. Suitably the support defines a scanning surface.

The coupling between the support and one or both of the transmitter and the receiver need not be direct. For example there may be at least one other material or structure between the transmitter and support and/or between the receiver and the support.

In some examples, the scanning apparatus is configured so that the support being in the non-planar configuration causes a scanning surface of the scanning apparatus to comprise one of, or a combination of a concave configuration, a convex configuration, a part-spherical configuration, and a configuration with a plurality of non-parallel planes.

An example of such a configuration is shown in FIG. 9. In this example the scanning apparatus 900 comprises a support 902. A transmitter and receiver, forming the transducer 904, are provided on the support. A dry coupling layer 906 is provided in front of the transducer. The support may comprise a material configured to absorb or attenuate ultrasound signals. In this way, reflections from behind the transmitter are reduced, which might otherwise interfere in the ultrasound scan.

The scanning apparatus is configured to scan an object 908. The surface profile of the support, and thereby the scanning apparatus is configured to match that of the object. In this example, the support adopts the shape of an outwardly-protruding triangle. This matches an inwardly-protruding triangular surface profile of the object. Thus the scanning apparatus can form a close fit with the object so as to efficiently scan within the object (for example to identify internal features 910 of the object).

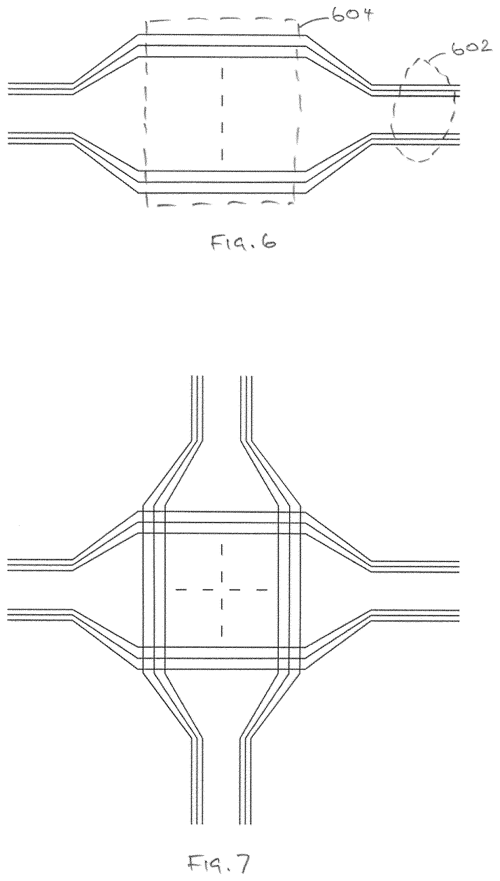

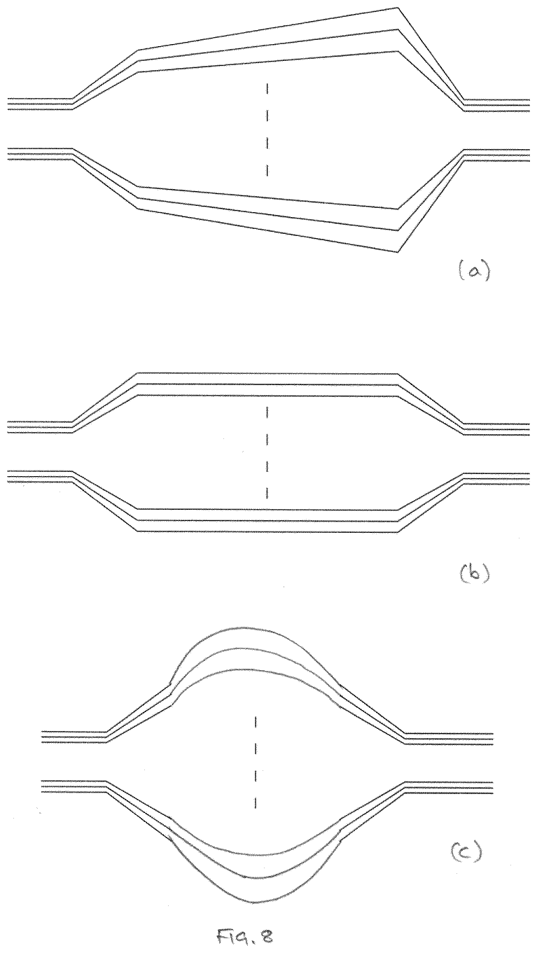

In other examples, illustrated in FIGS. 10a to 10c, the support 1002 can adopt, respectively, an inwardly-protruding triangle, a convex shape and a concave shape. In each case, the support adopts a non-planar configuration. Thus the scanning apparatus is conformable to corresponding non-planar surfaces of objects.

In some examples the non-planar configuration comprises a first plane coupled to a second plane. The two planes are coupled at an angle of less than 180 degrees to a first side of the planes and at an angle of greater than 180 degrees to a second side of the planes. The scanning apparatus is configured to scan objects to one or both of the first side and the second side.

Towards the first side of the planes, the planes are angled towards one another. The scanning apparatus may be located adjacent a convex or external corner of an object under test, with the corner being disposed towards the first side of the planes. Suitably, the scanning arrangement is configured such that the angle of the planes corresponds to the angle between external surfaces on the object. This approach enables the external corner of the object to fit into the angle defined by the first plane and the second plane such that the first plane is aligned with a first external surface of the object and the second plane is aligned with a second external surface of the object. This configuration enables the scanning apparatus to efficiently scan the object at or near to the corner. For example, the scanning apparatus is configured to scan the object at and to either side of the corner. The results from such a scan give a more enhanced view of the internal structure of the object at/near the corner. The present arrangement enables such a scan to be obtained using a single scanning apparatus, and in a single scan. This can increase the efficiency of scanning, since the scanning apparatus need not be moved first to one side of the corner, and then to another side of the corner.

Towards the second side of the planes, the planes are angled away from one another. The scanning apparatus may be located adjacent a concave or internal corner of an object under test, with the second side of the planes being disposed towards the corner. Suitably, the scanning arrangement is configured such that the angle of the planes corresponds to the angle between surfaces on the object that face towards one another into the corner. This approach enables the first plane and the second plane of the scanning apparatus to be received into the internal corner of the object such that the first plane is aligned with one surface of the object and the second plane is aligned with another surface of the object. This configuration enables the scanning apparatus to efficiently scan the object at or near to the corner. For example, the scanning apparatus is configured to scan the object at and to either side of the corner. The results from such a scan give a more enhanced view of the internal structure of the object at/near the corner. The present arrangement enables such a scan to be obtained using a single scanning apparatus, and in a single scan. This can increase the efficiency of scanning, since the scanning apparatus need not be moved first to one side of the corner, and then to another side of the corner.

In some examples, one or more transducer can be provided which faces towards the first side. In some examples, one or more transducer can be provided which faces towards the second side. In some examples, transducers may be placed back to back, so as to enable scanning to either the first side or the second side. In such examples, the side to which scanning is performed can be controlled by associated electronics.

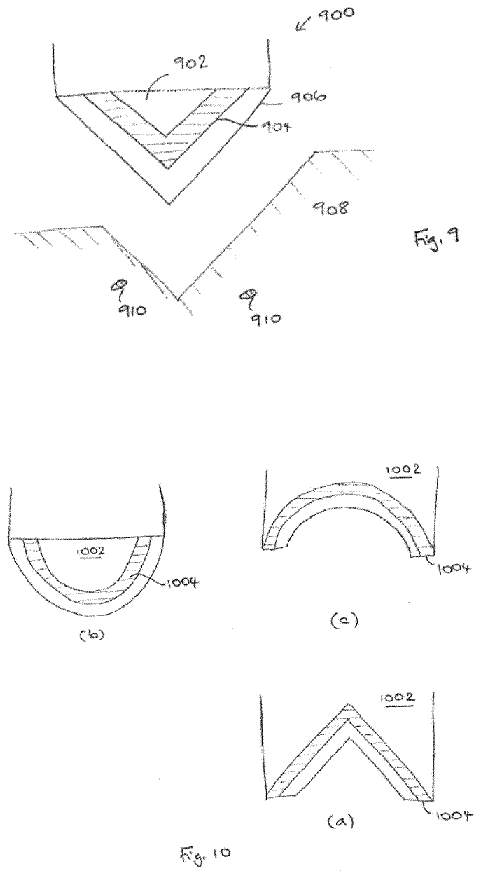

The first plane and the second plane need not be directly coupled together. For example there may be a join between the planes, such as a joint. Suitably, however, active portions of the scanning apparatus, for example portions comprising the transmitter and receiver, are provided close to the coupling between the first plane and the second plane. This arrangement allows the scanning apparatus to be used to scan at or near to a corner or bend in an object. An example of a scanning apparatus comprising a plurality of planes coupled by a joint is shown in FIG. 11. FIG. 11a shows two planes, generally indicated at 1101 and 1102. The planes are coupled by a hinge 1104. FIG. 11b shows three planes, generally indicated at 1105, 1106 and 1107. The planes are coupled by two hinges 1108, 1110. Each of the planes indicated in FIGS. 11a and 11b may form respective scanning modules. Each scanning module may comprise a respective transmitter, receiver and support portion.

Whilst planes are shown in FIGS. 11a and 11b, it will be understood that one or more of the section indicated may comprise a curved surface.

The hinge may have a resistance such that it can permit relative rotation of the planes about the hinge under action of a force that exceeds a threshold force. In some examples the hinge may be driven, for example by a motor coupled to the hinge. The driving of the hinge may be controlled by associated electronics. For example, where the surface shape of an object to be imaged is known, the hinge can be driven so as to cause the planes to adopt a non-planar configuration that is appropriate for imaging that object. In some examples, the hinge may be driven through a range of angles as the scanning apparatus is held in contact with an object. The range of angles is suitably a range of 10 degrees, a range of 5 degrees, or a range of 2 degrees. The scanning apparatus may scan the object as the hinge is driven through the range of angles. The angle at which the optimal scan results are obtained (for example results with the highest of a given quality measure or combination of quality measures) can be determined. The scan from this angle can be selected as the scan to further process and/or store. The determined angle can be selected for further scans.

The support may have a non-planar configuration when not acted upon by external forces. The support may adopt the non-planar configuration when at rest, e.g. when not pressed against an object.

The support may be arranged to adopt the non-planar configuration on pressing the scanning apparatus against a non-planar surface of an object. The support may be flexible.

The support may be flexible in one dimension. The support may be flexible in more than one dimension. In some examples, the support is flexible in a single dimension. This arrangement can allow the scanning apparatus to conform to different curvatures in that dimension. Such a scanning apparatus might, for example, be suitable for scanning across an aeroplane wing, where the curvature changes from a relatively higher curvature at the leading edge of the wing to a relatively lower curvature on top of the wing.

FIG. 12a shows an example of a transducer 1202 (the remainder of the scanning apparatus is omitted for clarity) that has adopted a non-planar configuration by flexing in one dimension.

There are several modes of operation of transducers comprising a matrix of transducer elements, as described herein. In one mode, a contiguous, or substantially contiguous group of transducers can be fired at once. The contiguous group of transducers might comprise all the transducers in the scanning apparatus. This mode can be used to emit a relatively more powerful pulse, which can be useful for detecting a rear wall of an object, for example so as to determine a thickness of that object. In another mode, transducer elements can be fired line-by-line (or in groups of lines), for example along a row or along a column of the matrix.

An example of a row of transducer elements being fired at once is shown in FIG. 12 at 1204. The transducer has flexed such that the rows of transducer elements remain linear. This is illustrated with reference to FIG. 12b. The arrows 1206 schematically show the emitted ultrasound pulse. Thus, firing along a line of transducer elements which remains linear in the non-planar configuration can enable the transmission of a pulse as for a flat matrix array. Thus the processing of the detected reflections can be performed in a standard way.

An example of a column of transducer elements being fired at once is shown in FIG. 12 at 1208. The transducer has flexed such that the columns of transducer elements adopt a curved path. This is illustrated with reference to FIG. 12c. The arrows 1210 schematically show the emitted ultrasound pulse. Thus, firing along a line of transducer elements which adopts a curved path in the non-planar configuration can enable the transmission of a pulse that can be focussed to a particular location within an object, without needing to modify the timing of the transmission to achieve the focussing effect. The focussing can suitably be more closely controlled by controlling the timing of the transmission of the pulses from each of the transducer elements along the column, in dependence on the curvature of the column.

More generally, the firing of one or more transducer element in dependence on the non-planar configuration adopted enables a greater control over the transmission of the ultrasound signals, for example the transmission direction and/or the transmission power.

Where the support is flexible in more than one dimension this can permit the scanning apparatus to conform to changes in curvature across an area of an object to be imaged.

Suitably the transmitter and the receiver are flexible. For example, the transmitter may comprise flexible transmitter circuitry and the receiver may comprise flexible receiver circuitry. Suitably the flexible transmitter circuitry and the flexible receiver circuitry are configured to conform to a non-planar surface of an object as the support adopts the non-planar configuration.

The scanning apparatus may be formed as a flexible blanket or mat, for example in the form of a square or rectangle, although arbitrary shapes are also possible. The shape in which the scanning apparatus is formed can be tailored to a desired use. For example, where a trapezoidal section of an object such as a wing section is to be scanned, the scanning apparatus used can take the form of a trapezoidal mat, sized to cover the trapezoidal section to be scanned (it might be larger than the section to be scanned, and need not be trapezoidal to scan a trapezoidal area). The scanning apparatus may therefore be draped over an object to be imaged. The flexibility of the scanning apparatus enables it to conform to the surface contours of the object. Forming the scanning apparatus as a blanket or mat can enable a larger area of the object to be scanned in one go. This can reduce overall scanning times for scanning the area of interest.

A scanning apparatus can comprise a plurality of transducers coupled together. Such an arrangement enables a relatively larger area to be scanned, whilst retaining the scanning resolution offered by a single transducer.

The scanning apparatus can comprise a lip such as a flexible lip. The lip can extend away from a body of the scanning apparatus. This arrangement is illustrated in FIG. 32. The scanning apparatus is indicated generally at 3200. The scanning apparatus comprises a body 3202. The body comprises electronics for driving the transmitter and for receiving signals from the receiver. In the illustrated example, the body houses a backing block 3204 which is used to attach the support to the body. The backing block need not be provided in all examples. The support is indicated generally at 3206. The support comprises a portion 3208 abutting the body 3202 and a lip 3210 extending from the body. The support comprises a backing material 3212 and a coupling material 3214. The backing material and the coupling material sandwich the transducer 3216, i.e. they are provided to either side of the transducer. The transducer comprises the transmitter and the receiver.

Suitably the support is flexible. The lip may be more flexible than the portion of the support abutting the body 3202. The portion of the support abutting the body may, in some implementations, be rigid. The portion of the support abutting the body may retain the general shape of an edge of the body, such as a flat surface as illustrated.

Suitably the lip is configured to flex in at least one dimension. Preferably the lip is able to flex in two dimensions. The lip may form part of a flexible blanket or mat, for example as described elsewhere herein.

In FIG. 32 the lip couples to a flat portion of the support. The lip may alternatively couple to any other shaped support as described herein. The portion of the support abutting the body need not be flat, but can adopt any suitable shape, such as a protruding shape, for example a convex curve, and/or a recessed shape, for example a concave curve. Examples of such shapes are given in FIGS. 9 and 10.

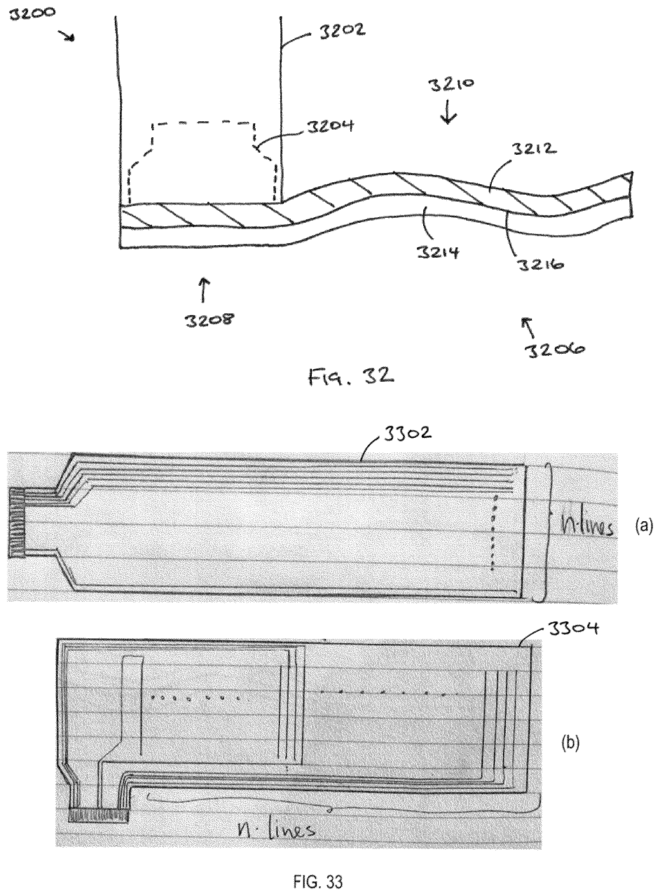

FIG. 33 illustrates an example of transmitter and receiver electrodes 3302 3304 for use in the scanning apparatus of FIG. 32. The transmitter and receiver electrodes both comprise n lines of conductive material on a flexible layer. The two sets of n lines are arranged so that they cross one another when the electrodes are overlaid. The points at which the lines cross define the transmitting and receiving elements. The electrodes are assembled to sandwich a piezoelectric layer between the electrodes. The number, n, of lines can be selected as desired to provide a matrix array of transmitting and receiving elements of a desired size and resolution. When the electrodes 3302 3304 are assembled together with the piezoelectric layer between the electrodes, the resulting arrangement can form the transducer 3216.

Suitably the provision of the lip as part of the scanning apparatus does not necessitate a modification in the electronics and control system of the scanning apparatus. Thus, electrodes of a transducer coupled to a support that comprises a lip can couple to the scanning apparatus electronics and control system in the same manner as electrodes of a transducer coupled to a support that does not comprise a lip. For example, the same number of electrodes can be provided in the transducer, whether or not the support to which that transducer is coupled comprises a lip This can be appreciated by considering FIG. 33(a). A portion of the electrode 3302 will be at the part of the support abutting the body of the scanning apparatus, and a portion of the electrode will be at the lip. The electrode lines extend from the portion of the electrode 3302 near the body of the scanning apparatus to the lip. The number of electrode lines need not increase. Thus the control of each of the n lines can be effected using the same electronics and control system.

The provision of the lip on the scanning apparatus permits the scanning apparatus to effectively scan corners of structures, or areas in which materials overlap or join with other materials. Such areas can be of particular importance in non-destructive testing applications. For example, corners can be areas of high stress. Carbon fibre materials may be bent around a corner, and it is important to be able to effectively analyse the material where the fibres bend. Alternatively, different materials may join at a corner, and it can be important to be able to effectively analyse such joins, for example where different sets and/or orientations of fibres may be adjacent one another. Further, in some applications it can be difficult to get resin into corners in a consistent manner. It is therefore important to be able to analyse the resin at the corners to be able to identify any defects that may be present.

The lip can be placed on a test object around a corner. The corner be angled inwardly or outwardly, or there may be a combination of inward and outward bends. The flexible lip is able to accommodate this range of corner shapes or bends. The lip suitably lies on the test object such that the transducer is generally perpendicular to the surface of the test object along its length, or along at least a substantial portion of its length, for example along at least half of its length or along at least three quarters of its length. This arrangement can help improve coupling of sound into and out of the test object and can help improve accuracy in the resulting analysis of the interior of the test object.

Where the lip is placed over a corner, the characteristics of the lip can be used to improve the accuracy of the analysis of the corner. For example, the lip may have a particular radius of curvature, for example 10 mm. When the lip is placed over a 90 degree bend, the radius of curvature of the lip can be taken into account and the processing of signals (in transmission and/or reception of the signals) can compensate for the radius of curvature. This approach can improve the accuracy of the analysis.

### Coupling Shoe

The description above describes how a scanning apparatus can be enabled to scan a non-planar object. In examples above, the scanning apparatus can be operated with a support in a non-planar configuration. Another approach to enabling scanning of non-planar objects will now be described. It is noted that this other approach can be used together with the approach(es) above, in any desired combination of features, and/or independently. This increases the flexibility of use of the system.

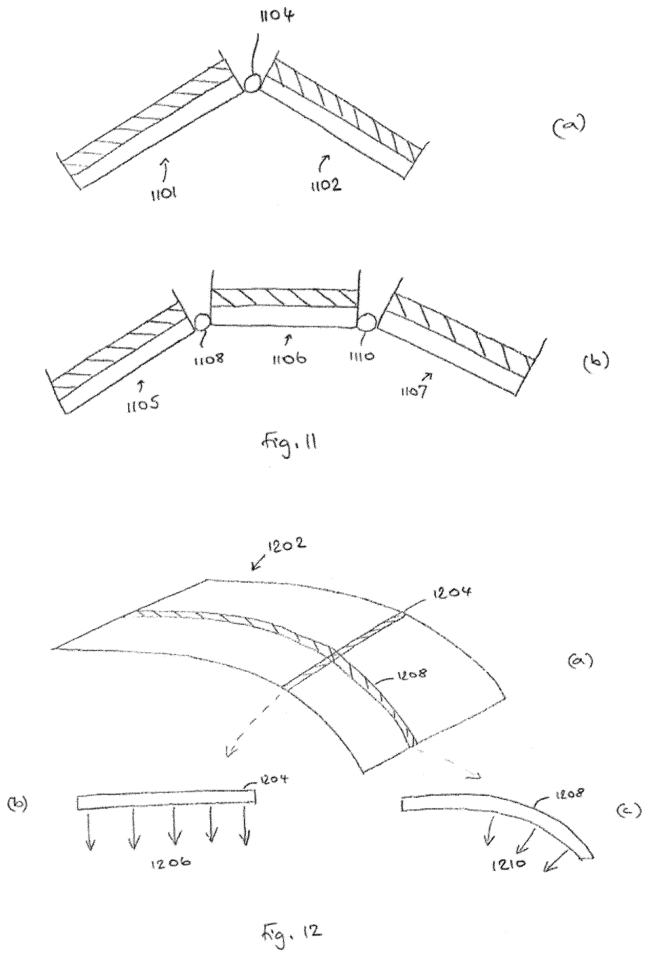

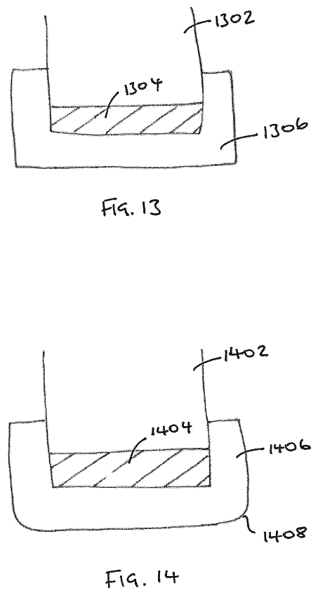

With reference to FIG. 13, a transducer module 1302 comprises a transducer 1304. The transducer module may be provided with a dry coupling located in front of the transducer in a direction in which ultrasound signals are transmitted towards an object under test. The dry coupling is not shown in FIG. 13. A coupling shoe 1306 is suitably provided for attachment to the transducer module. The coupling shoe can be attachable to the transducer module in any convenient manner. For example, the coupling shoe may comprise a recess in an upper portion thereof, sized for engaging with the transducer module via an interference fit. The coupling shoe may be attachable to the transducer module by a snap-fit connection, by engaging with a shoe holder which is attachable to the transducer module, or in any other convenient way.

The coupling shoe suitably comprises a material which permits ultrasound signals to pass therethrough. The coupling shoe comprises a transducer coupling surface which is arranged to be adjacent an ultrasound-emitting surface of a transducer module, such as when the transducer module is located in the recess. The transducer coupling surface can abut the ultrasound-emitting surface of the transducer module so as to couple ultrasound into the coupling shoe. The coupling shoe comprises a probe surface arranged to face a target object. The probe surface is for coupling ultrasound into the target object. The coupling shoe comprises a side surface which forms at least a part of a periphery of the coupling shoe. The side surface is transverse to at least one of the transducer coupling surface and the probe surface.

Suitably the coupling shoe is impedance-matched to the transducer. This can reduce or avoid undesirable reflections at the transducer-coupling shoe interface, e.g. at the transducer coupling surface of the coupling shoe. In this way, energy of the transmitted ultrasound can be permitted to efficiently pass into the coupling shoe. The coupling shoe may comprise a resilient material. The coupling shoe may comprise an elastomer. The coupling shoe may comprise one or more of an Aqualene material, an ACE material, an AquaSilox material and an Aqualink material (available from Innovation Polymers, Canada). Examples of such materials include:
Aqualene 300 (Shore A hardness of 58; attenuation (at 5 MHz) of 0.35 dB/mm);
Aqualene 320 (Shore A hardness of 35; attenuation (at 5 MHz) of 0.15 dB/mm);
Aqualene 200 (Shore A hardness of 40; attenuation (at 5 MHz) of 0.48 dB/mm);
ACE 400 (Shore A hardness of 40; attenuation (at 5 MHz) of 0.5 dB/mm);
ACE 410 (Shore A hardness of 42; attenuation (at 5 MHz) of 0.77 dB/mm);
AquaSilox 100 (Shore A hardness of 23; attenuation (at 5 MHz) of 0.8 dB/mm); and
Aqualink 100 (Shore A hardness of 5; attenuation (at 5 MHz) of 0.4 dB/mm).

The coupling shoe may comprise a hard material. The coupling material may comprise plexiglass. The coupling material may comprise a cross-linked plastic. The coupling material may comprise Rexolite (available from C-Lec Plastics Inc.).

The coupling shoe may be provided with a thickness as desired. The thickness of the coupling shoe may be determined in dependence on one or more of the depth of the object under test, the depth of a rear surface of the object under test, the depth of a feature of interest of the object under test, a material of the object under test, and a frequency or range of frequencies of ultrasound for transmission through the coupling shoe.

In some circumstances it will be desirable to provide a liquid coupling medium for more effectively coupling transmitted ultrasound into an object under test and/or more effectively coupling reflected ultrasound signals from the object towards the transducer. Such a liquid coupling may comprise a gel, such as a water-based gel, or water.

With reference to FIG. 14, a transducer module 1402 comprising a transducer 1404 can be provided with a coupling shoe 1406. The coupling shoe comprises rounded corners 1408. Such rounded corners (or curved edges) can permit a liquid coupling medium to flow between the coupling shoe and the object. Sharp corners can tend to scrape the coupling medium off a surface of an object. Thus, the provision of curved edges on the coupling shoe can increase the coupling of ultrasound into and out of the object. This can lead to an increase in accuracy of the ultrasound scans.

The probe surface of the coupling shoe, i.e. the surface facing an object towards which ultrasound is to be transmitted, need not be planar. The probe surface of the coupling shoe need not be parallel to the transducer coupling surface. Alternative configurations of the coupling shoe can enable a transducer module to more effectively inspect objects of different shapes without needing the transducer itself to be modified. Note however, that such modifications of the transducer, for example as described elsewhere herein, may be used together with the different coupling shoes described herein.

One example of a coupling shoe is illustrated in FIG. 15. The coupling shoe 1506 comprises a curved probe surface 1508. The curved probe surface enables the coupling shoe to more closely match the curvature of a curved object, such as a spherical (or part spherical) object or a cylindrical (or part cylindrical) object. For example, the coupling shoe 1506 can be used to enable a better coupling between the transducer module and an external surface of a pipe. Another view of the coupling shoe of FIG. 15 is shown in FIG. 16. FIG. 16 shows that the curvature extends in one direction, such that the coupling shoe comprises a concave cylindrical curved surface. Thus the coupling shoe illustrated in FIG. 16 can be used to couple a transducer module to an external surface of a pipe.

The coupling shoe may be resilient. The resilience of the coupling shoe can accommodate differences in the curvature between the coupling shoe probe surface 1508 and the external surface of a pipe. The tolerance in the curvature mismatch that can be accommodated with the coupling shoe will depend on the resilience of the coupling shoe. Different sizes of coupling shoe may be provided. Preferably, coupling shoes will be provided with curvatures that match common pipe curvatures.

Referring again to FIG. 15, the circumference of a circle part defined by the curvature of the probe surface 1508 of the coupling shoe 1506 is illustrated by the dashed line 1510. The diameter of this circle is indicated at 1512. Suitably the curvature of the coupling shoe is configured to match a standard pipe diameter. For example, coupling shoes may be provided with curvatures configured to match the following pipe diameters: 100 mm, 150 mm, 200 mm, 250 mm, 300 mm, 500 mm, and so on.

The curvature of the probe surface 1508 need not be in a single direction as illustrated in FIG. 16. In other examples, the curvature may be the same in orthogonal directions, such that the coupling shoe comprises a spherically concave surface or part-spherically concave surface. The coupling shoe may comprise a probe surface with different curvatures. For example, the coupling shoe may be configured to match the curvature of a pipe elbow. Different sizes of coupling shoe may be provided that match the curvatures of pipe elbows of different pipes, for example pipes of standard diameters (as above) and/or pipes that bend through differing angles.

FIG. 17 shows another example of a coupling shoe 1706. The illustrated coupling shoe comprises a probe surface 1708 with a convex curve. The probe surface 1708 is preferably a spherical or part spherical curve. Thus the coupling shoe 1706 can be used to couple to a rounded inside corner of an object under test. Different sizes of coupling shoe may be provided that are configured to match different radii of curvature, so as to provide effective coupling to a range of curvatures of objects under test.

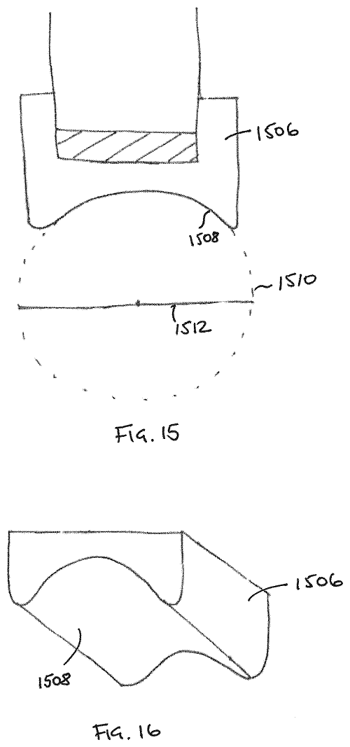

FIG. 18 shows illustrations of alternative configurations of coupling shoes 1806, 1807. The upper coupling shoe 1806 comprises a wedge-shaped recess or indentation in the probe surface 1808. The lower coupling shoe 1807 comprises a wedge-shaped protrusion in the probe surface 1809. These coupling shoes are configured for adapting to outside or inside angles, respectively, of a test object.

FIG. 19 illustrates another configuration of a coupling shoe 1906. The illustrated coupling shoe is useful for imaging around a weld 1910 in a test object 1912. The coupling shoe comprises a probe surface which can be aligned with a surface of the test object 1912 such that the transducer module 1902 is held at an angle to the surface normal. This enables the transducer module to transmit ultrasound signals through the test object at an angle to the surface normal. The coupling shoe may be asymmetrical about a longitudinal axis of the transducer module to which it is to be coupled. A portion of the coupling shoe to one side 1906a may extend further to one side of the transducer module than a portion of the coupling shoe to the other side 1906b. This can assist in locating the transducer module so as to image underneath the weld.

The coupling shoes described above are configured for attachment to a single transducer module. In some situations it will be desirable to provide a coupling shoe to which a plurality of transducer modules may be attachable. For example, a single transducer module may need to be moved along a surface or across a test object to obtain the desired scan. Using a coupling shoe that can attach to more than one transducer module at a time can mean that a greater portion of a test object can be scanned at once compared to using a single transducer module. Such an arrangement can facilitate a faster scan. It can also have advantages in terms of scan alignments, since there will be a known relationship between the transducer modules attached to a single coupling shoe. This can simplify subsequent processing of data obtained from different transducer modules.

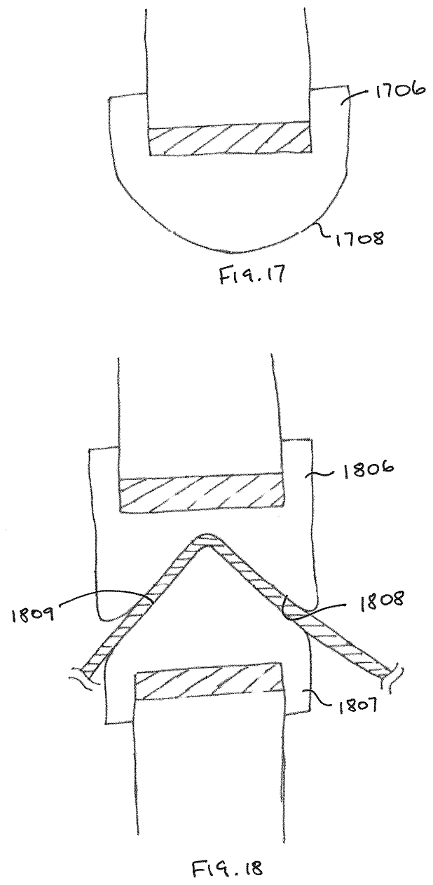

An example of such a coupling shoe is illustrated in FIG. 20. The coupling shoe 2006 comprises a plurality or recesses (here, four) for receiving transducer modules 2002a, 2002b, 2002c, 2002d. The probe surface of the coupling shoe can be configured as desired, depending on the test object to be scanned. As illustrated, the probe surface of the coupling shoe 2006 comprises a concave curved portion for engagement with an external surface of a pipe 2012. This arrangement of transducer modules in the coupling shoe 2006 can permit a scan to be taken of a greater portion of the circumference of the pipe (compared to using a single transducer module) by simply moving the coupling shoe with the plurality of transducer modules attached along the longitudinal axis of the pipe.

The coupling shoe 2006 shown in FIG. 20 can attach to four transducer modules. In other examples the coupling shoe can be configured to attach to a larger or smaller number of transducer modules. For example, in one arrangement, a coupling shoe can be configured for engagement around the whole circumference of a pipe, or around a majority of the circumference of a pipe. To achieve this, the coupling shoe may be resilient so as to be attachable to the outside of the pipe. The coupling shoe may comprise a flexible portion such as a joint to enable the coupling shoe to be attachable to the outside of the pipe. Transducer modules may then be provided for attachment to the coupling shoe such that the transducer modules surround the pipe. Thus this arrangement permits the circumference of the pipe to be scanned at once by moving such a coupling shoe along the length of the pipe.

### Ultrasound-Attenuating Structure

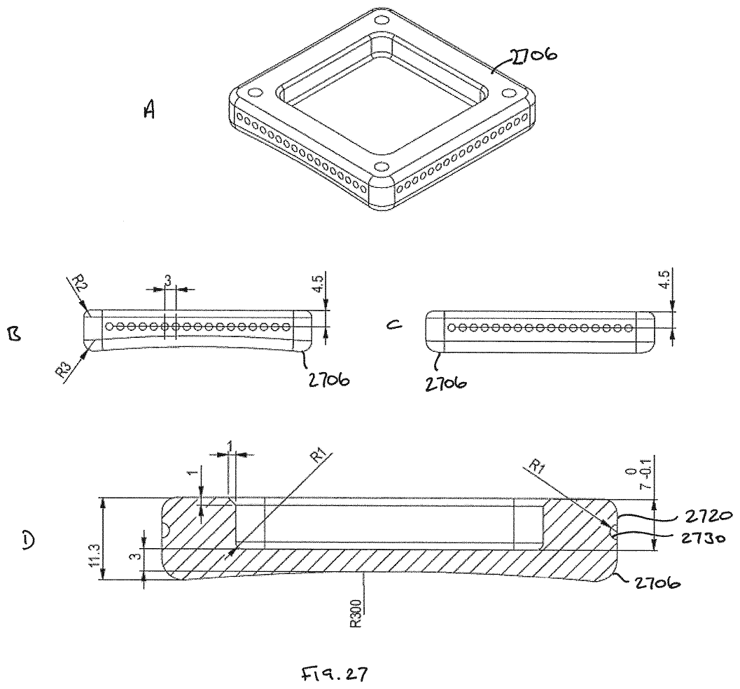

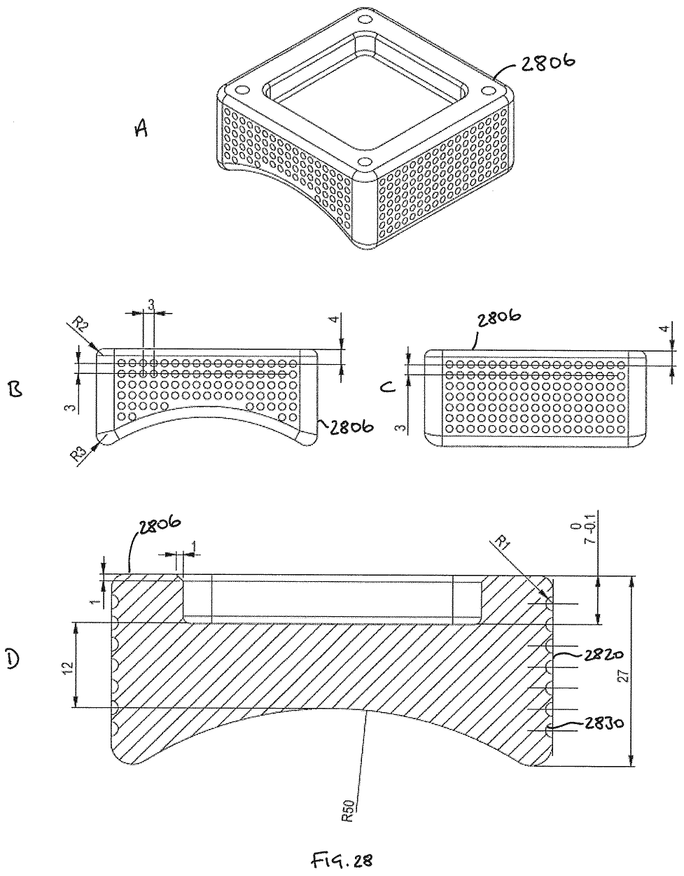

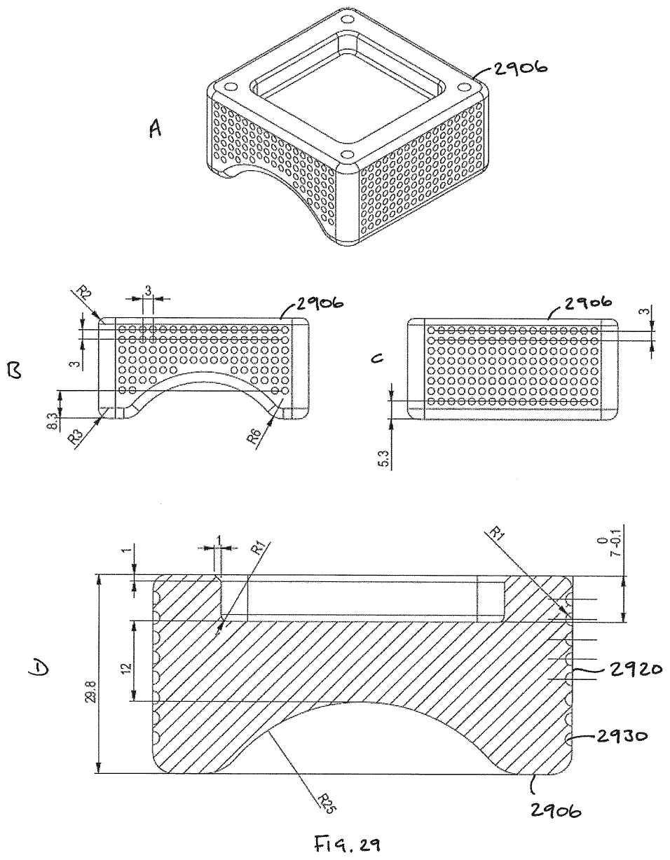

The periphery of the coupling shoe can comprise an ultrasound-attenuating structure. The ultrasound-attenuating structure can further enhance the accuracy of the scan by reducing side reflections. The ultrasound-attenuating structure will now be described with reference to FIGS. 21 to 29. Such an ultrasound-attenuating structure can be utilised in any of the coupling shoes described herein, or indeed any other suitable coupling shoe.

Such an ultrasound-attenuating structure can usefully reduce or avoid unwanted reflections from or within the periphery of the coupling shoe, for example reflections from the side surface. Such unwanted reflections can arise due to beam spreading of the transmitted ultrasound beam transmitted by the transducer. A transmitted ultrasound beam will have a certain beam width. The beam width may be defined as a width across which the intensity of the beam exceeds a proportion of the maximum intensity of the beam. Thus the beam width quantifies a width across which a given proportion of the energy of the beam is transmitted. The width can be controlled by selecting the number of transducers. For example, a greater number of transducers can increase the beam focus, which can reduce the beam width. A relatively more focused beam may spread less than a relatively less focused beam.

However, any given beam is likely to comprise sideways shear waves, at least to some extent. These shear waves can reflect off the side surface of the coupling shoe, leading to spurious reflections that can reduce the accuracy of data obtained. The spurious reflections are not caused by interfaces of or within the object under test, and so do not pertain to the structure of the object or its location. It is therefore desirable to reduce or avoid these sideways reflections within the coupling shoe so as to improve accuracy.

FIG. 21 illustrates a coupling shoe 2016 comprising an ultrasound-attenuating structure 2120. The ultrasound-attenuating structure comprises a flared portion. The side surface is angled outwardly in a direction from the transducer coupling surface to the probe surface. The ultrasound-attenuating structure can act to increase the path length of reflections from the side of the coupling shoe. An increased path length can lead to a greater attenuation of a signal that travels along that path. Thus, the ultrasound-attenuating structure can increase the attenuation of side reflections, and thereby reduce the energy of such side reflections that might be detected at the transducer. The angle 2121 by which the side surface flares outwardly can be selected in dependence on one or more of the thickness of the coupling shoe, the frequency or range of frequencies of the transmitted beam, the material of the test object, the material of the coupling shoe, the feature to be imaged, the depth of the feature to be imaged, and so on.

An increase in angle is likely to reduce the side reflections received at the transducer, by causing more reflections away from the transducer. However, a larger angle will increase the area of the probe surface of the coupling shoe. A balance is therefore desirable between a coupling shoe that has a flared portion that is large enough to reduce side reflections yet small enough so that the coupling shoe remains compact and easy to use.

Suitably the side surface is angled outwardly by an angle 2121 that is less than approximately 45 degrees, or less than approximately 35 degrees, or less than approximately 25 degrees, or less than approximately 15 degrees, or less than approximately 10 degrees, or less than approximately 5 degrees, or less than approximately 3 degrees, or less than approximately 2 degrees. Suitably the angle 2121 is selected such that the side reflections received at the transducer are reduced in intensity by at least approximately 50%, at least approximately 75%, at least approximately 80%, at least approximately 85%, at least approximately 90%, at least approximately 95%.

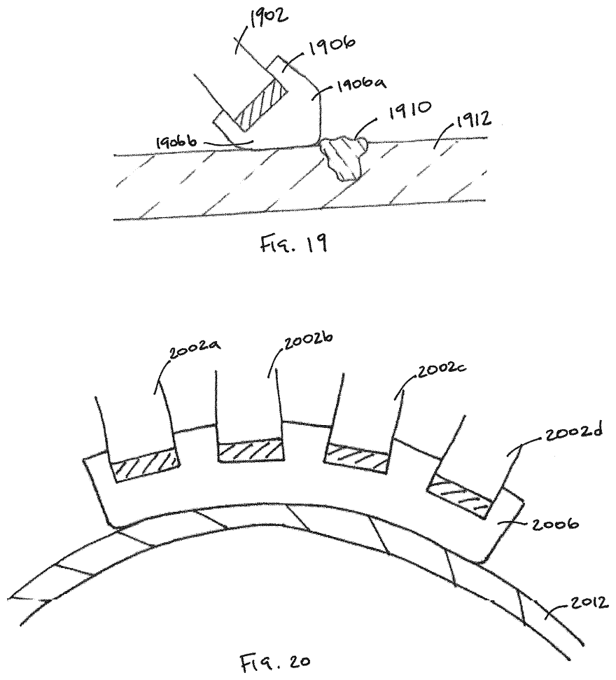

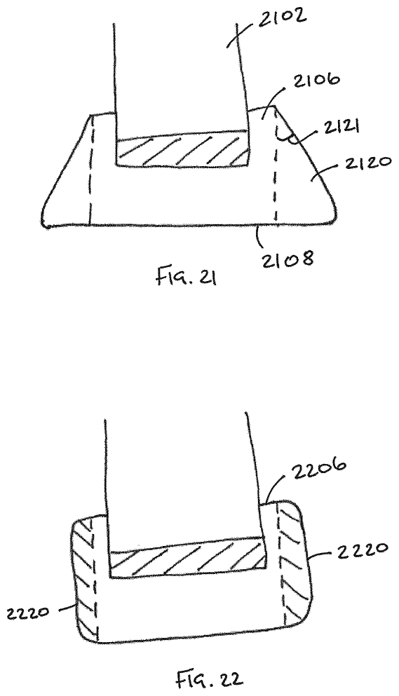

The ultrasound-attenuating structure may additionally or alternatively comprise a sound-absorbing material. This is illustrated schematically in FIG. 22. The coupling shoe 2206 comprises ultrasound-attenuating structures 2220 which comprise material that is different from the remainder of the coupling shoe, such as a bulk of the coupling shoe. Suitably, the material of the coupling shoe is impedance-matched to one or both of the transducer and the object under test. This can reduce reflections at the transducer-coupling shoe boundary (e.g. at the transducer coupling surface) and/or at the coupling shoe-object boundary (e.g. at the probe surface). Suitably the coupling shoe material is highly transparent to the ultrasound frequencies which are to be transmitted and reflected. This is to reduce or minimise attenuation of the transmitted and reflected signals by the coupling shoe.

The ultrasound-attenuating structure may comprise or act as a damping layer. For example, the ultrasound-attenuating structure may comprise or be formed of an epoxy and/or iron oxide. The ultrasound-attenuating structure may comprise particles of impedance-mismatched material, such as metal particles or powder. The particles may be dispersed throughout the ultrasound-attenuating structure.

Suitably the particles can have a range of sizes. Thus the particles may present an irregular series of interfaces to signals propagating through the ultrasound-attenuating structure. Suitably the particles range in size from particles having a largest dimension of X μm to particles having a largest dimension of Y μm. Preferably, X=0.1 μm. Preferably Y=500 μm. X may be greater than or equal to 0.1 μm, 0.5 μm, 1 μm, 2 μm, 5 μm or 10 μm, and so on. Y may be less than or equal to 500 μm, 450 μm, 400 μm or 300 μm, and so on. Preferably the size of the largest dimension of the particles, and/or the range of sizes of the largest dimension of the particles depends on the frequency or frequency range of ultrasound for absorption and/or scattering by the ultrasound-attenuating structure.

The plurality of particles may comprise spherical particles. The plurality of particles may comprise particles other than spherical particles. The plurality of particles may comprise particles of different shapes. The provision of particles of different shapes can help cause irregular reflections of ultrasound signals within the ultrasound-attenuating structure. The irregular reflections can cause increased numbers of reflections and/or path length.

The plurality of particles can comprise particles of a plurality of materials. Suitably the different materials have different acoustic impedances. Thus the particles of different materials will reflect ultrasound signals differently. This can assist in irregular reflections within the ultrasound-attenuating structure, which can lead to an increased number of reflections and/or an increased path length. At least some of the particles may be in a powdered form.

Suitably the particles comprise a metal. The particles may comprise a plurality of metals. The plurality of particles may comprise particles of one or more of tungsten, nickel, titanium, titanium dioxide, steel and iron oxide. Other materials may be provided as desired. Suitably the material of the particles provided in the ultrasound-attenuating structure is selected in dependence on a desired acoustic impedance of the ultrasound-attenuating structure. For example, the inclusion of steel particles into material of the ultrasound-attenuating structure can cause the acoustic impedance of the ultrasound-attenuating structure to become more similar to that of steel. Thus such an ultrasound-attenuating structure comprising steel particles can be used for impedance-matching to a steel material.

The particles can be provided in any desired concentration in the ultrasound-attenuating structure. Suitably, the concentration of particles in the ultrasound-attenuating structure is selected in dependence on the frequency or frequencies of ultrasound that the ultrasound-attenuating structure is configured to absorb and/or scatter. The particles may form at least 10% (by weight) of the ultrasound-attenuating structure. The particles may form at least 20% (by weight) of the ultrasound-attenuating structure. The particles may form at least 30% (by weight) of the ultrasound-attenuating structure. The particles may form at least 50% (by weight) of the ultrasound-attenuating structure. The particles may form at least 80% (by weight) of the ultrasound-attenuating structure.

The presence of such particles in the ultrasound-attenuating structure can cause additional reflections within the ultrasound-attenuating structure, increasing the path length of signals within the ultrasound-attenuating structure. Such increased path lengths can lead to increased attenuation of the side reflections. Losses in signal intensity will also occur with each reflection. Thus increasing the number of reflections will increase the reflection losses. The ultrasound-attenuating structure may be impedance-matched to the material of the bulk of the coupling shoe at the boundary between the ultrasound-attenuating structure and the bulk of the coupling shoe. This can reduce or avoid reflections at this boundary, enabling a greater proportion of signals directed sideways to enter the ultrasound-attenuating structure and thereby be attenuated in the ultrasound-attenuating structure. The impedance of the ultrasound-attenuating structure may change within the ultrasound-attenuating structure. The impedance of the ultrasound-attenuating structure may change progressively within the ultrasound-attenuating structure, for example with increasing distance from the boundary between the ultrasound-attenuating structure and the bulk of the coupling shoe.

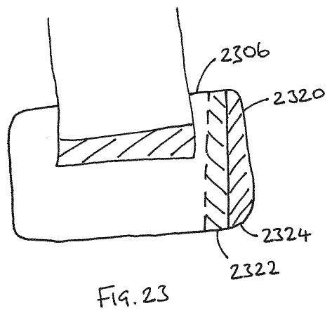

The ultrasound-attenuating structure may comprise a plurality of layers. Referring to FIG. 23, the ultrasound-attenuating structure 2320 of the coupling shoe 2306 can comprise two layers 2322, 2324. A first layer 2322, adjacent the bulk of the coupling shoe, can be impedance-matched to the bulk of the coupling shoe. A second layer 2324, provided outside the first layer, can be of a different impedance to the first layer. The second layer may be of the same impedance as the first layer. The second layer may comprise particles of a material with a different impedance to the bulk of the second layer. Whilst the example illustrated in FIG. 23 comprises two layers, a greater number of layers may be provided. The layers can differ in the material and/or compositions used. For example the layers may comprise materials with the same or differing bulk impedances. The layers may comprise particles of a material with differing impedance from the bulk impedance of the respective layer. A layer may comprise a number, concentration and/or density of particles that is different from a number, concentration and/or density of particles in another layer, for example a neighbouring layer.

The ultrasound-attenuating structure may comprise protrusions or indentations (or recesses). Such protrusions or indentations may be provided with features or combination of features of the ultrasound-attenuating structure, or of the coupling shoe, described elsewhere herein. Examples of such indentations will be described with reference to FIGS. 24 to 29. It will be understood that, whilst the following description is provided in the context of indentations, protrusions may be provided instead of or as well as indentations. Where both protrusions and indentations are provided, the indentations and protrusions may be alternated with one another. The protrusions may take the same general shapes as any one of or any combination of the indentations described.

FIG. 24 shows a section of a transducer module 2402 and a coupling shoe 2406 attached to the transducer module. The coupling shoe 2406 comprises an ultrasound-attenuating structure 2420. As illustrated the ultrasound-attenuating structure 2420 comprises a series of indentations 2430. The indentations 2430 are provided in a side surface of the ultrasound-attenuating structure 2420. The indentations are provided in the side surface from the bottom of the side surface to a portion of the side surface that is roughly level with the transducer 2404. In alternative implementations, the indentations may be provided along a greater or lesser extent of the side surface. For example, the indentations may be provided along the entire vertical extent of the side surface. The indentations may be provided along a lowermost portion of the side surface, an uppermost portion of the side surface or a mid-portion of the side surface. The indentations may be provided along about 75%, about 50%, about 25% of the side surface.

Suitably the protrusions and/or indentations in the side surface present a non-planar interface to ultrasound signals propagating within the ultrasound-attenuating structure. The ultrasound-attenuating structure suitably comprises surface irregularities. The surface irregularities may present a non-planar interface to ultrasound signals propagating within the coupling shoe. This arrangement can cause scattering of ultrasound signals reflecting off the side surface.

The indentations illustrated in FIG. 24 comprise part-spherical indentations. The indentations may be hemispherical indentations. The indentations may have a diameter of between approximately 1 mm and approximately 5 mm. The indentations may all have the same diameter. The indentations may have a range of diameters. The indentations need not be part-spherical. Any other suitable shape indentation may be provided. The indentations may be curved indentations, non-spherical ellipsoid indentations, paraboloid indentations, and so on. The indentations may be angular. An example of such indentations in an ultrasound-attenuating structure 2520 is shown in FIG. 25A. The angle between the side faces of the indentations and the normal of the side surface is preferably less than about 45 degrees, more preferably less than about 35 degrees, more preferably less than about 25 degrees.

The indentations need not be adjacent one another along the side surface of the coupling shoe. In examples illustrated in FIGS. 25B and 25C, part-spherical and angled indentations are spaced from one another along the side surface. The spacing between neighbouring indentations may be between about 0.1 mm and about 10 mm. Suitably the spacing is approximately 0.5 mm, approximately 1 mm, approximately 2 mm.

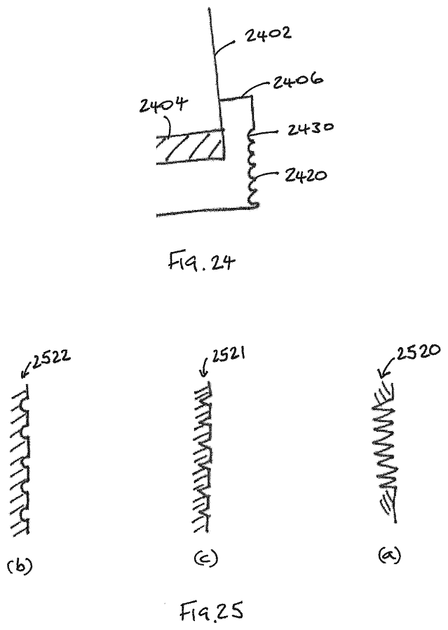

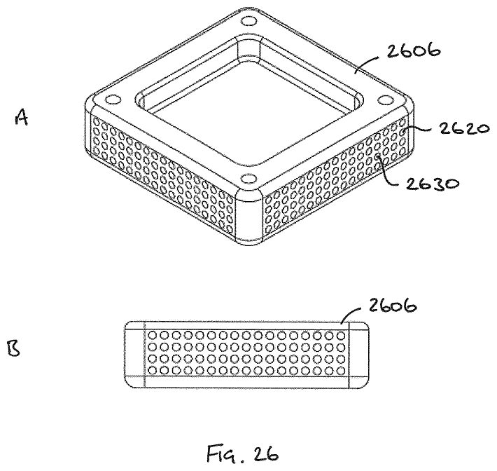

Examples of coupling shoes comprising ultrasound-attenuating structures having indentations are illustrated in FIGS. 26 to 29. FIG. 26 illustrates a coupling shoe 2606 for coupling to a flat (or substantially flat) object. Indentations 2630 are provided in an ultrasound-attenuating structure 2620 of the coupling shoe 2606. FIGS. 27 to 29 illustrate example coupling shoes 2706, 2806, 2906 that have curved probe surfaces for coupling to pipes of different diameters. Respective ultrasound-attenuating structures 2720, 2820, 2920 comprise indentations 2730, 2830, 2930.

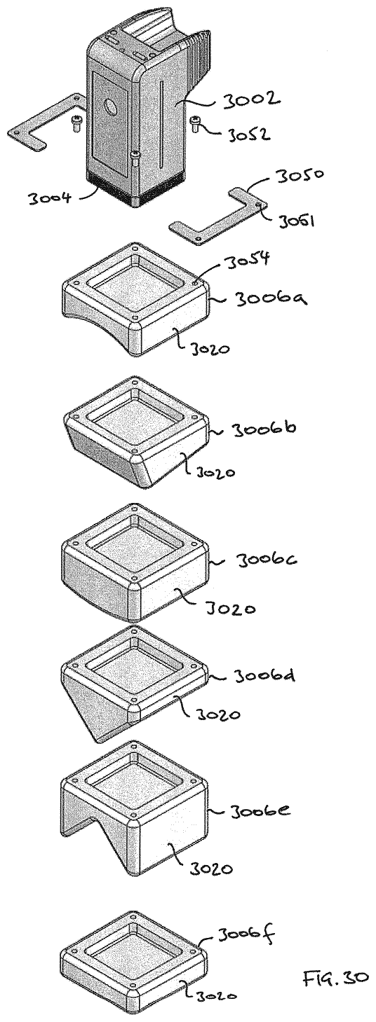

FIG. 30 shows an example transducer module 3002 comprising a transducer 3004. Different coupling shoes 3006a-f are illustrated. Any one or more of the coupling shoes may comprise an ultrasound-attenuating structure 3020, for example an ultrasound-attenuating structure as described herein. FIG. 30 shows an example of how a coupling shoe may be attached to the transducer module. In the example illustrated, two coupling plates 3050 may engage with the transducer module. The coupling plates may engage with horizontal slots on an exterior of the transducer module, or in any other convenient manner. The coupling plates comprise holes 3051 through which screws 3052 may pass. The screws suitably engage with holes 3054 in the coupling shoes. Thus, the coupling plates may engage with the transducer module and the coupling shoes can be attached to the coupling plates. Hence the coupling shoe can be held fast relative to the transducer module.

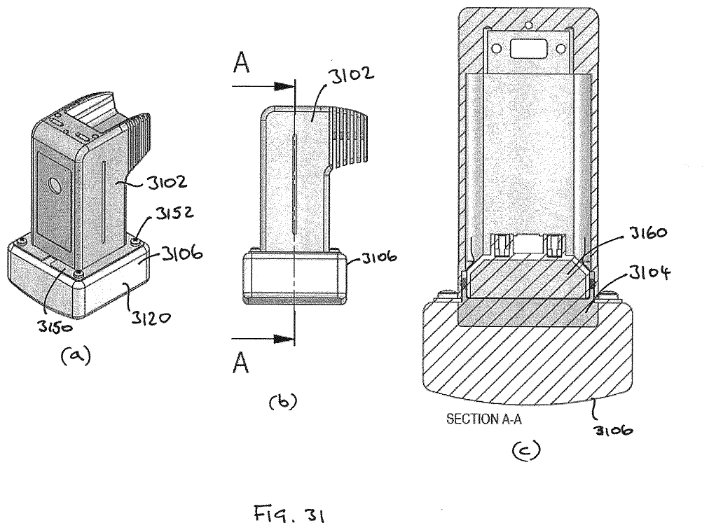

FIG. 31A shows a transducer module 3102 attached to a coupling shoe 3106 using coupling plates 3150 and screws 3152. FIG. 31C shows a section view taken along line A-A in FIG. 31B. A backing block 3160 is shown above the transducer 3104 in the transducer module 3102.

The apparatus and methods described herein are particularly suitable for detecting debonding and delamination in composite materials such as carbon-fibre-reinforced polymer (CFRP). This is important for aircraft maintenance. It can also be used detect flaking around rivet holes, which can act as a stress concentrator. The apparatus is particularly suitable for applications where it is desired to image a small area of a much larger component. The apparatus is lightweight, portable and easy to use. It can readily be carried by hand by an operator to be placed where required on the object.

In one implementation, the transducer could be formed in a pen tip, for example to allow a user to run the pen over a surface for performing a simple thickness test—whether greater than a threshold or not. An LED on the pen can indicate the result.

The structures shown in the figures herein are intended to correspond to a number of functional blocks in an apparatus. This is for illustrative purposes only. The functional blocks illustrated in the figures represent the different functions that the apparatus is configured to perform; they are not intended to define a strict division between physical components in the apparatus. The performance of some functions may be split across a number of different physical components. One particular component may perform a number of different functions. The figures are not intended to define a strict division between different parts of hardware on a chip or between different programs, procedures or functions in software. The functions may be performed in hardware or software or a combination of the two. Any such software is preferably stored on a non-transient computer readable medium, such as a memory (RAM, cache, FLASH, ROM, hard disk etc.) or other storage means (USB stick, FLASH, ROM, CD, disk etc). The apparatus may comprise only one physical device or it may comprise a number of separate devices. For example, some of the signal processing and image generation may be performed in a portable, hand-held device and some may be performed in a separate device such as a PC, PDA or tablet. In some examples, the entirety of the image generation may be performed in a separate device. Any of the functional units described herein might be implemented as part of the cloud.

The applicant hereby discloses in isolation each individual feature described herein and any combination of two or more such features, to the extent that such features or combinations are capable of being carried out based on the present specification as a whole in the light of the common general knowledge of a person skilled in the art, irrespective of whether such features or combinations of features solve any problems disclosed herein, and without limitation to the scope of the claims. The applicant indicates that aspects of the present invention may consist of any such individual feature or combination of features. In view of the foregoing description it will be evident to a person skilled in the art that various modifications may be made within the scope of the invention.

1. A scanning apparatus for imaging an object, the scanning apparatus comprising:
a transmitter for transmitting ultrasound signals towards an object,
a receiver for receiving ultrasound signals from an object, and
a support defining a scanning surface, the transmitter and the receiver being coupled to the support;
the scanning apparatus being capable of being operated with the support in a non-planar configuration thereby to scan a non-planar surface of an object;
in which the scanning apparatus is configured to control the transmission of ultrasound signals by the transmitter in dependence on the configuration of the support.

2. A scanning apparatus according to claim 1, in which the scanning apparatus is configured so that the support being in the non-planar configuration causes a scanning surface of the scanning apparatus to comprise one of, or a combination of:
a concave configuration,
a convex configuration,
a part-spherical configuration, and
a configuration with a plurality of non-parallel planes.

3. (canceled)

4. A scanning apparatus according to claim 1, in which the scanning apparatus is configured to control one or more of:
a linear array of transducer elements to transmit an ultrasound signal, and
a non-linear array of transducer elements to transmit an ultrasound signal.

5. (canceled)

6. A scanning apparatus according to claim 1, in which the support is one or more of:
arranged to adopt the non-planar configuration on pressing the scanning apparatus against a non-planar surface of an object, and flexible.

7. (canceled)

8. A scanning apparatus according to claim 1, in which the support comprises a flexible lip extending away from a body of the scanning apparatus.

9. A scanning apparatus according to claim 8, in which a portion of the support abutting the body of the scanning apparatus is more rigid than the lip.

10. A scanning apparatus according to claim 8, in which the lip is configured to flex in two dimensions.

11. A scanning apparatus according to claim 1, in which the support has a non-planar configuration when not acted upon by external forces.

12. A scanning apparatus according to claim 1, in which, where the non-planar configuration comprises a first plane coupled to a second plane, the two planes being coupled at an angle of less than 180 degrees to a first side of the planes and at an angle of greater than 180 degrees to a second side of the planes, the scanning apparatus is configured to scan objects to one or both of the first side and the second side.

13. A scanning apparatus according to claim 12, in which the scanning apparatus comprises one transmitter disposed on the first plane and another transmitter disposed on the second plane.

14. A scanning apparatus according to claim 13, in which the scanning apparatus comprises a further transmitter disposed back to back with one of the transmitter on the first plane and the transmitter on the second plane.

15. A scanning apparatus according to claim 1, in which the transmitter and the receiver respectively comprise first and second transmitters and receivers, and the support comprises first and second support portions, the scanning apparatus comprising:
a first scanning module comprising the first transmitter, the first receiver, and the first support portion, the first transmitter and the first receiver being coupled to the first support portion, and
a second scanning module comprising the second transmitter, the second receiver, and the second support portion, the second transmitter and the second receiver being coupled to the second support portion;
wherein the first scanning module and the second scanning module are movable relative to one another so as to enable the support to adopt the non-planar configuration.

16. A scanning apparatus according to claim 15, in which:
the first scanning module and the second scanning module are pivotally movable relative to one another, and/or one or both of the first scanning module and the second scanning module comprise one of, or a combination of, a curved surface and a planar surface.

17. (canceled)

18. A scanning apparatus according to claim 1, in which the scanning apparatus comprises a coupling material for facing an object for imaging.

19. A method of operating an ultrasound scanning apparatus for imaging an interior of an object, the scanning apparatus comprising a matrix array of transducer elements configured to transmit and receive ultrasound signals, the method comprising:
determining a non-planar configuration of the matrix array; and
controlling the matrix array to emit ultrasound signals in dependence on the determined non-planar configuration.

20. A method according to claim 19, in which controlling the matrix array comprises controlling a linear array of transducer elements of the matrix array to emit an ultrasound signal.

21. A method according to claim 19, in which controlling the matrix array comprises controlling a non-linear array of transducer elements of the matrix array to emit an ultrasound signal.

22. A method of operating an ultrasound scanning apparatus for imaging an interior of an object, the scanning apparatus comprising a matrix array of transducer elements configured to transmit and receive ultrasound signals, the method comprising:
modifying the matrix array thereby to cause the matrix array to adopt a non-planar configuration;
moving the scanning apparatus into contact with an object;
controlling the matrix array to emit ultrasound signals and to receive reflected ultrasound signals.

23. A method according to claim 22, in which modifying the matrix array comprises driving a joint between two portions of the matrix array.

24. A method according to claim 22, in which at least one of the portions of the matrix array comprises a plurality of transducer elements arranged on a common plane.

25-48. (canceled)
